(19) United States
(12) Patent Application Publication
(10) Pub. No.: US 2026/0297958 A1
(43) Pub. Date: Oct. 1, 2026

(54) WOOD-BASED PANEL

(71) Applicant: UNILIN, BV, Wielsbeke (BE)

(72) Inventors: Marijn SEYNAEVE, Wielsbeke (BE); Sam LEDEGEN, Wielsbeke (BE); Samuel KRAMAR, Wielsbeke (BE)

(21) Appl. No.: 19/479,011

(22) PCT Filed: Apr. 11, 2024
(86) PCT No.: PCT/IB2024/053530

§ 371 Date: Oct. 27, 2025

Related U.S. Application Data
(60) Provisional application No. 63/498,527, filed on Apr. 27, 2023.

(30) Foreign Application Priority Data
Jun. 23, 2023 (EP) 23181211.6

(51) Int. Cl. E04F 15/10; B32B 7/12; B32B 21/02; B32B 21/04; B32B 21/06; B32B 29/00; B32B 29/06; B32B 33/00

(52) U.S. Cl. CPC E04F 15/107; B32B 7/12; B32B 21/02; B32B 21/042; B32B 21/06; B32B 29/002; B32B 29/06; B32B 33/00; E04F 15/102; B32B 2250/05; B32B 2260/026; B32B 2260/046; B32B 2375/00; B32B 2391/00; B32B 2419/04

(57) ABSTRACT

A wood-based panel includes a wood-based board and a décor layer. The décor layer optionally has a décor directly printed onto the wood-based board or the décor layer optionally includes a printed paper sheet. The wood-based board at least has a layer including wood chips and/or wood fibers bonded by a thermoplastic halogen-free binder; and optionally by a thermoset binder.

The invention relates to wood based panels that can be used as floor panels.

WO97/4534A1 discloses a floor covering consisting of wood-based floor panels which, at least at the edges of two opposite sides, are provided with coupling parts, cooperating with each other, substantially in the form of a tongue and a groove. The coupling parts are provided with integrated mechanical locking means preventing the drifting apart of two coupled floor panels into a direction perpendicular to the related edges and parallel to the underside of the coupled floor panels. The wood-based floor panels can comprise a core comprising finely-ground wood glued together. The core can be provided by an HDF board (High Density Fibreboard) or an MDF board (Medium Density Fibreboard).

It is an object of the invention to provide wood-based panels that can be used as floor covering having better sound attenuation. It is an object of the invention to provide such wood-based panels having better sound attenuation which are more environmentally friendly in production and/or in composition.

The first aspect of the invention is a wood-based panel. The wood-based panel comprises a wood-based board and a décor layer. The wood-based board at least comprises a B-layer, wherein the B-layer comprises wood chips and/or wood fibers bonded by a thermoplastic halogen-free binder; and optionally by a thermoset binder.

The term B-layer is used to identify this specific layer.

It is a benefit of wood-based panels of the first aspect of the invention that less sound is generated when walking on floor coverings formed by such wood-based panels. It is believed that this better sound dampening is achieved by the use of the thermoplastic halogen-free binder.

The wood-based panels of the first aspect of the invention have the further benefit that the water resistance is improved. It is believed that the improved water resistance is—at least in part—obtained by the fact that the thermoplastic halogen-free binder fills voids in the B-layer, resulting in less voids in the B-layer which could absorb water.

The décor layer optionally comprises a décor directly printed onto the wood-based board; or the décor layer optionally comprises a—preferably resin impregnated—printed paper sheet.

A preferred embodiment is characterized in that the B-layer has a thickness less than 35% of the thickness of the wood-based board.

The inventors have observed that such wood-based panels provide good sound dampening when walked upon when installed as floor covering.

The thermoplastic halogen-free binder is preferably selected from the list of polyvinyl butyral (PVB), styrene butadiene copolymer, ethylene vinyl acetate (EVA), polylactic acid (PLA), vinyl acetate-ethylene-vinyl ester copolymers, biobased polyester—e.g. polyhydroxyalkanoates—, thermoplastic polyurethanes, thermoplastic starch, polyolefines, thermoplastic acrylates, or mixtures thereof.

Such thermoplastic halogen-free binders provide good sound dampening properties to such wood-based panels.

The use of polyvinyl butyral (PVB) is preferred as it provides improved water resistance to the panel.

The use of styrene butadiene copolymer is preferred as it has a low processing temperatures, which ensures that it can easily be combined with the wood chips and/or the wood fibers.

The fraction by volume of the thermoplastic halogen-free binder in the combination of the wood chips and/or wood fibers on the one hand; and on the other hand the thermoplastic halogen-free binder is preferably at least 10 percent, more preferably at least 15 percent.

Such embodiments provide good sound dampening properties to floor coverings installed with such wood-based panels.

A preferred embodiment is characterized in that the B-layer comprises wood chips and/or wood fibers bonded by a thermoplastic halogen-free binder and by a thermoset binder.

The combination of the thermoplastic halogen-free binder and the thermoset binder provides an excellent bonding of the B-layer, excellent mechanical properties to the panel and good sound dampening properties.

The thermoset binder of the B-layer is preferably selected from the list of polyurethane, hyperbranched polyamide (optionally in combination with a crosslinking agent), thermoset polyester, isocyanates; or mixtures thereof.

More preferably, the B-layer comprises 1 to 25 (and more preferably 1 to 15) parts by weight of the thermoset binder for every 100 parts by weight of the combination of wood chips and wood fibers in the B-layer. Such panels have shown to provide an optimized combination of mechanical properties and sound dampening properties.

In embodiments of the first aspect of the invention wherein the B-layer comprises a thermoset binder, the thermoset binder preferably provides at least 4 percent by weight (and more preferably at least 7 percent by weight) of the B-layer. Such panels have shown to provide an optimized combination of mechanical properties and sound dampening properties.

A preferred embodiment of the first aspect of the invention is characterized in that the B-layer comprises wood chips; and that the mass fraction of the wood chips of the B-layer larger than 3 mm as measured via sieve analysis is less than 5 percent (and preferably less than 2 percent) of the total mass of wood chips in the B-layer.

Such embodiment has shown to provide an improved panel in terms of the ability to mill coupling parts on the wood-based panel. The inventors believe this is due to the fact that the voids in the B-layer are smaller thanks to the smaller wood chips being used.

Such embodiment has the further benefit that telegraphing—wood chips that are visible at the surface of the panel—is avoided in embodiments wherein the B-layer is the topmost wood-based layer of the wood-based board.

More preferably, the mass fraction of the wood chips of the B-layer larger than 2 mm as measured via sieve analysis is less than 5 percent (and preferably less than 2 percent) of the total mass of wood chips in the B-layer.

Within the context of the different aspects of the invention, the sieve analysis is performed by means of sieving using a horizontal sieve shaker apparatus (e.g. the Retsch AS400) with sieves having different aperture sizes according to ISO 3310-1:2016 “Test sieves—Technical requirements and testing—Part 1: Test sieves of metal wire cloth”. The eccentric sieve is put in operation during 10 minutes at 2520 revolutions per minute using 250 gram chips to be tested. After these 10 minutes, the different fractions are weighed.

A preferred embodiment of the first aspect of the invention is characterized in that the B-layer is a wood particle board layer comprising wood chips and a thermoplastic halogen-free binder; and optionally a thermoset binder; wherein the mass fraction of the wood chips of the B-layer smaller than 1 mm as measured via sieve analysis is more than 50 percent; and preferably more than 60 percent, and preferably more than 70 percent, of the total mass of wood chips in the B-layer.

Such embodiments provide optimized performance of the panel, as the B-layer is better suited for milling coupling parts onto the panel. The inventors believe this is due to the fact that the voids in the B-layer are smaller thanks to the smaller wood chips being used.

Preferably, the mass fraction of the wood chips in the B-layer with size between 0.3 mm and 2 mm is at least 80 wt % of the total mass of wood chips in the B-layer, and preferably more than 85 wt %, more preferably at least 90 wt %. This ratio can be determined via sieve analysis on the wood chips used to manufacture the B-layer.

A preferred embodiment of the first aspect of the invention is characterized in that the B-layer comprises wood chips; wherein the fraction by mass of fine chips in the B-layer is larger at the front side of the B-layer than at the back of the B-layer. The wood chips of the B-layer have a size distribution. It is meant in this embodiment that the relative amount of fine chips at the front of the B-layer (being the side of the B-layer directed to the décor layer) is higher than at the other side of the B-layer. Such embodiments can be realized by using a blower when scattering the wood chips to form the B-layer, such that the deposition of wood chips of different size is different in time.

Such embodiments have the benefit that the front surface of the B-layer is flatter and shows less pores. This is beneficial in embodiments wherein the décor layer is contacting the front surface of the B-layer as a better quality visual appearance of the décor layer is obtained.

A preferred embodiment of the first aspect of the invention is characterized in that the B-layer comprises wood chips; and that in the B-layer the wood chips of wood having a density less than 500 kg/m³ (and more preferably less than 400 kg/m³, even more preferably less than 350 kg/m³) provide at least 7 wt %—and more preferably at least 10 wt %, even more preferably at least 15 wt %, even more preferably at least 20 wt %—of all wood chips in the B-layer.

Such embodiments have the benefit that coupling parts for coupling the wood-based panels, e.g. in a floating floor covering, can be milled more easily. This is believed to be because for a same B-layer density, the use of the softer wood chips results in less voids and pores in the B-layer.

Preferably, the B-layer comprises wax. More preferably, the B-layer comprises at least 0.5 wt % of wax, and even more preferably at least 0.75 wt % of wax. More preferably, the B-layer comprises less than 2 wt % wax.

Such embodiments have the benefits that the panel better resists the absorption of water and that less edge swelling occurs when the panel edges are exposed to water.

A preferred embodiment of the first aspect of the invention is characterized in that the décor layer comprises a décor directly printed onto the B-layer or the décor layer comprises a—preferably resin impregnated—printed paper sheet laminated onto the B-layer, or the décor layer comprises a High Pressure Laminate laminated onto the B-layer.

With High Pressure Laminate is preferably meant a laminate comprising a resin impregnated printed sheet of paper, one or more layers of Kraft paper, and optionally a wear layer (e.g. comprising a resin impregnated sheet of paper, optionally comprising wear resistant particles such as corundum); all laminated together.

A High Pressure Laminate can be laminated to its substrate—e.g. onto the B-layer—using an adhesive.

The second aspect of the invention is a wood-based panel, optionally a wood-based panel as in any embodiment of the first aspect of the invention. The wood-based panel of the second aspect of the invention comprises a wood-based board and a décor layer. The wood-based panel comprises an A-layer. The A-layer has a thickness less than 35 % of the wood-based panel. The A-layer comprises wood chips and/or wood fibers bonded by a thermoset resin, preferably by a polyurethane resin.

The term A-layer is used to identify this specific layer.

Wood-based panels of the second aspect of the invention in which a polyurethane resin is used have the benefit that thanks to the use of the polyurethane resin improved sound dampening properties are provided, e.g. when using the wood-based panel in a floor covering, while the cost of the wood-based panel can be limited, as the thickness of the B-layer relative to the thickness of the wood-based board is kept limited.

The décor layer optionally comprises a décor directly printed onto the wood-based board, or the décor layer optionally comprises a—preferably resin impregnated—printed paper sheet.

A preferred embodiment of the second aspect of the invention is characterized in that the thermoset resin—preferably a polyurethane resin—provides at least 4 percent by weight—and preferably at least 7 percent by weight—of the A-layer; and preferably less than 15 percent by weight of the A-layer, and more preferably less than 10 percent by weight of the A-layer.

Such embodiments provide the synergistic benefit that the cost of the wood-based panel can be kept limited, while excellent mechanical properties and sound dampening properties are obtained.

A preferred embodiment of the second aspect of the invention is characterized in that the A-layer comprises wood chips; and that the mass fraction of the wood chips of the A-layer larger than 3 mm as measured via sieve analysis is less than 5 percent (and preferably less than 2 percent) of the total mass of wood chips in the A-layer; preferably wherein the mass fraction of the wood chips of the A-layer larger than 2 mm as measured via sieve analysis is less than 5 percent (and preferably less than 2 percent) of the total mass of wood chips in the A-layer.

Such embodiments provide optimized performance of the panel, as the A-layer is better suited for milling coupling parts onto the panel. The inventors believe this is due to the presence of less voids thanks to the smaller wood chips being used. The inventors believe this is due to the fact that the voids in the A-layer are smaller thanks to the smaller wood chips being used.

Such embodiment has the further benefit that telegraphing—wood chips that are visible at the surface of the panel—is avoided in embodiments wherein the A-layer is the topmost wood-based layer of the wood-based board.

A preferred embodiment of the second aspect of the invention is characterized in that the A-layer is a wood particle board layer comprising wood chips bonded by a polyurethane resin; wherein the mass fraction of the wood chips of the A-layer smaller than 1 mm as measured via sieve analysis is more than 50 percent; and preferably more than 60 percent, and preferably more than 70 percent, of the total mass of wood chips in the A-layer.

Such embodiments provide optimized performance of the panel, as the A-layer is better suited for milling coupling parts onto the panel. The inventors believe this is due to the presence of less voids thanks to the smaller wood chips being used. The inventors believe this is due to the fact that the voids in the A-layer are smaller thanks to the smaller wood chips being used.

Such embodiment has the further benefit that telegraphing—wood chips that are visible at the surface of the panel—is avoided in embodiments wherein the A-layer is the topmost wood-based layer of the wood-based board.

Preferably, the mass fraction of the wood chips in the A-layer with size between 0.3 mm and 2 mm is at least 80 wt % of the total mass of wood chips in the A-layer, and preferably more than 85 wt %, more preferably at least 90 wt %. This ratio can be determined via sieve analysis on the wood chips used to manufacture the A-layer.

A preferred embodiment of the second aspect of the invention is characterized in that the A-layer comprises wood chips; wherein the fraction by mass of fine chips in the A-layer is larger at the front side of the A-layer than at the back of the A-layer. The wood chips of the A-layer have a size distribution. It is meant in this embodiment that the relative amount of fine chips at the front of the A-layer (being the side of the A-layer directed to the décor layer) is higher than at the other side of the A-layer. Such embodiments can be realized by using a blower when scattering the wood chips to form the A-layer, such that the deposition of wood chips of different size is different in time.

Such embodiments have the benefit that the front surface of the A-layer is flatter and shows less pores. This is beneficial in embodiments wherein the décor layer is contacting the front surface of the A-layer as a better quality visual appearance of the décor layer is obtained.

A preferred embodiment of the second aspect of the invention is characterized in that the A-layer comprises wood chips; and that in the A-layer the wood chips of wood having a density less than 500 kg/m³ (and more preferably less than 400 kg/m³, even more preferably less than 350 kg/m³) provide at least 7 wt %—and more preferably at least 10 wt %, even more preferably at least 15 wt %, even more preferably at least 20 wt %—of all wood chips in the A-layer.

Such embodiments have the benefit that coupling parts for coupling the wood-based panels, e.g. in a floating floor covering, can be milled more easily. This is believed to be because for a same A-layer density, the use of the softer wood chips results in less voids and pores in the A-layer.

Preferably, the A-layer comprises wax. More preferably, the A-layer comprises at least 0.5 wt % of wax, and even more preferably at least 0.75 wt % of wax. More preferably, the A-layer comprises less than 2 wt % wax.

Such embodiments have the benefits that the panel better resists the absorption of water and that less edge swelling occurs when the panel edges are exposed to water.

A preferred embodiment of the second aspect of the invention is characterized in that the wood-based panel is a wood-based panel according to any embodiment of the first aspect of the invention; and that the A-layer is provided between the B-layer and the décor layer.

The B-layer comprises a thermoplastic halogen-free binder. Such thermoplastic halogen-free binder can be sticky and stick to transporting equipment (e.g. a belt) in production processes in which wood particles or wood fibers are scattered together with particles of the thermoplastic halogen-free binder onto the transporting equipment. Such problems are avoided when an A-layer is used, as the particles of the B-layer can be scattered onto the particles providing the A-layer. The A-layer does not show such potential stickiness issues.

A further benefit of the presence of the A-layer between the B-layer and the décor layer is the wider versatility of décor layer that can be laminated directly onto the A-layer than directly onto the B-layer.

It is a further benefit that the A-layer minimizes surface defects in the thermal press operation in which a décor layer is laminated into the wood-based panel. Such defects could occur when the B-layer is the layer onto which the décor layer is laminated due to the presence of the thermoplastic halogen-free binder.

A preferred embodiment of the second aspect of the invention is characterized in that the décor layer comprises a décor directly printed onto the A-layer or the décor layer comprises a—preferably resin impregnated—printed paper sheet laminated onto the A-layer, or the décor layer comprises a High Pressure Laminate laminated onto the A-layer.

With High Pressure Laminate is preferably meant a laminate comprising a resin impregnated printed sheet of paper, one or more layers of Kraft paper, and optionally a wear layer (e.g. comprising a resin impregnated sheet of paper, optionally comprising wear resistant particles such as corundum); all laminated together.

A High Pressure Laminate can be laminated to its substrate—e.g. onto the A-layer—using an adhesive.

The third aspect of the invention relates to a wood-based panel as in any embodiment of the first aspect of the invention and/or as in any embodiment of the second aspect of the invention. The wood-based panel of the third aspect of the invention is characterized in that the wood-based board comprises a C-layer, wherein the C-layer provides more than 40%—and preferably more than 50%—of the thickness of the wood-based board. The C-layer is a wood particle board layer comprising wood chips and a binder; or the C-layer is a wood fiber board comprising wood fibers and a binder.

Wood-based panels according to the third aspect of the invention comprise on the one hand a C-layer, and on the other hand a B-layer according to the first aspect of the invention and/or an A-layer according to the second aspect of the invention. The C-layer provides a carrier layer for the A-layer and/or for the B-layer. The presence of the C-layer allows to reduce the raw material cost of the wood-based panel, while maintaining excellent mechanical and sound-dampening properties of the wood-based panel.

A preferred embodiment of the third aspect of the invention is characterized in that the binder of the C-layer comprises or consists of a thermoset binder. Such embodiments provide C-layers (and wood-based panels) having excellent mechanical properties.

The thermoset binder of the C-layer can be selected from the list of urea formaldehyde resin, melamine urea formaldehyde resin, diisocyanate (e.g. methylene difenyl di-isocyanate or a polymeric methylene difenyl di-isocyanate) polyurethane, hyperbranched polyamide (optionally in combination with a crosslinking agent), thermoset polyester, or mixtures thereof.

The use of melamine urea formaldehyde resin is particularly preferred as it results in a wood-based panel with better water resistance.

Preferably, the thermoset binder provides at least 4 wt %—and preferably at least 8 wt %—of the C-layer; and preferably less than 20 wt % of the C-layer, more preferably less than 15 wt % of the C-layer.

A preferred embodiment of the third aspect of the invention is characterized in that the C-layer is a wood particle board layer comprising wood chips and a binder; wherein the mass fraction of the wood chips of the C-layer larger than 8 mm as measured via sieve analysis is less than 5 percent (and preferably less than 2 percent) of the total mass of the wood chips of the C-layer. More preferably, the mass fraction of the wood chips of the C-layer larger than 7 mm as measured via sieve analysis is less than 5 percent (and preferably less than 2 percent) of the total mass of the wood chips of the C-layer.

Such embodiments have shown to provide an improved wood-based panel in terms of the ability to mill coupling parts on the wood-based panel. The inventors believe this is due to the fact that the voids in the C-layer are smaller thanks to the smaller wood chips being used.

A preferred embodiment of the third aspect of the invention is characterized in that the C-layer is a wood particle board layer comprising wood chips and a binder; wherein the mass fraction of the wood chips of the C-layer larger than 5 mm as measured via sieve analysis is less than 5 percent (and preferably less than 2 percent) of the total mass of the wood chips of the C-layer. More preferably, the mass fraction of the wood chips of the C-layer larger than 4 mm as measured via sieve analysis is less than 5 percent (and preferably less than 2 percent) of the total mass of the wood chips of the C-layer.

Such embodiments have shown to provide an improved wood-based panel in terms of the ability to mill coupling parts on the wood-based panel. The inventors believe this is due to the fact that the voids in the C-layer are smaller thanks to the smaller wood chips being used.

A preferred embodiment of the third aspect of the invention is characterized in that the C-layer is a wood particle board layer comprising wood chips and a thermoset binder; wherein the mass fraction of the wood chips of the C-layer smaller than 6 mm as measured via sieve analysis is more than 50 percent; preferably more than 60 percent, more preferably more than 70 percent, even more preferably more than 80 percent, of the total mass of wood chips in the C-layer.

Such embodiments have shown to provide an improved wood-based panel in terms of the ability to mill coupling parts on the wood-based panel. The inventors believe this is due to the fact that the voids in the C-layer are smaller thanks to the smaller wood chips being used.

A preferred embodiment of the third aspect of the invention is characterized in that the C-layer is a wood particle board layer comprising wood chips and a thermoset binder; wherein the mass fraction of the wood chips of the C-layer smaller than 4 mm as measured via sieve analysis is more than 50 percent; preferably more than 60 percent, more preferably more than 70 percent, even more preferably more than 80 percent, of the total mass of wood chips in the C-layer.

Such embodiments have shown to provide an improved wood-based panel in terms of the ability to mill coupling parts on the wood-based panel. The inventors believe this is due to the fact that the voids in the C-layer are smaller thanks to the smaller wood chips being used.

A preferred embodiment of the third aspect of the invention is characterized in that the C-layer is a wood particle board layer comprising wood chips and a binder; wherein in the wood particle board layer the wood chips of wood having a density less than 500 kg/m³ (and preferably less than 400 kg/m³, more preferably less than 350 kg/m³) provide at least 7 wt %—and preferably at least 10 wt %, more preferably at least 15 wt %, even more preferably at least 20 wt %—of all wood chips in the C-layer.

Such embodiments have the benefit that coupling parts for coupling the wood-based panels, e.g. in a floating floor covering, can be milled more easily. This is believed to be because for a same C-layer density, the use of the softer wood chips results in less voids and pores in the C-layer. When the amount of voids and pores in the C-layer is lower, the coupling parts can be milled more precisely and with a cleaner cut.

A preferred embodiment of the third aspect of the invention is characterized in that the density of the C-layer is more than 700 kg/m³, preferably more than 725 kg/m³, more preferably more than 750 kg/m³, even more preferably more than 775 kg/m³.

Such embodiments are preferred as coupling parts of better quality can be milled at the edges of the wood-based panel for coupling the wood-based panels, e.g. to form a floating floor covering.

C-layers of such high density can be made e.g. using fine wood chips and/or using at least in part wood chips of wood having a low density. The use of fine wood chips as well as the use at least in part of wood chips of wood having a low density result in reduced content and reduced cumulated volume of voids in the C-layer, beneficial for the quality of milled coupling parts.

A preferred embodiment of the third aspect of the invention is characterized in that the C-layer comprises wax, more preferably wherein the C-layer comprises at least 0.5 wt % of wax, and even more preferably at least 0.75 wt % of wax. More preferably, the C-layer comprises less than 2 wt % wax.

Such embodiments have the benefits that the panel better resists the absorption of water and that less edge swelling occurs when the panel edges are exposed to water.

A preferred embodiment of the third aspect of the invention is characterized in that the wood-based panel is a panel as in any embodiment of the first aspect of the invention; wherein the B-layer is provided between the C-layer and the décor layer.

If is a benefit of such embodiments that the C-layer provides a carrier or core to the wood-based panel, whereas the B-layer is located more closely to the décor layer, such that the sound dampening properties of the B-layer are optimally exploited in the wood-based panel.

A preferred embodiment of the third aspect of the invention is characterized in that the wood-based panel is a panel as in the second aspect of the invention, wherein the A-layer is provided between the C-layer and the décor layer.

A preferred embodiment of the third aspect of the invention is characterized in that at the other side of the wood-based panel than the location of the décor layer, the wood-based board comprises a D-layer; wherein the D-layer comprises wood chips and/or wood fibers bonded by a thermoplastic halogen-free binder; and/or by a thermoset binder.

The term D-layer is used to identify this specific layer.

The D-layer can provide a balancing layer in the wood-based panel for a B-layer and/or for an A-layer.

Preferably, the D-layer has a thickness less than 35% of the thickness of the wood-based board.

More preferably, the D-layer has the same thickness as—if present—the B-layer or the A-layer, or of the combination of the A-layer and the B-layer, such that an optimum balancing effect is obtained.

The D-layer preferably comprises wood chips and/or wood fibers bonded by a thermoplastic halogen-free binder; and/or by a thermoset binder; wherein the thermoplastic halogen-free binder of the D-layer is preferably selected from the list of polyvinyl butyral (PVB), styrene butadiene copolymer, ethylene vinyl acetate (EVA), polylactic acid (PLA), vinyl acetate-ethylene-vinyl ester copolymers, biobased polyester—e.g. polyhydroxyalkanoates—, thermoplastic polyurethanes, thermoplastic starch, thermoplastic acrylates, polyolefines or mixtures thereof.

In the D-layer, the fraction by volume of the thermoplastic halogen-free binder in the combination of the wood chips and/or wood fibers on the one hand and on the other hand the thermoplastic halogen-free binder is preferably at least 10 percent, more preferably at least 15 percent, more preferably at least 20 percent.

A preferred D-layer comprises wood chips and/or wood fibers bonded by a thermoplastic halogen-free binder and by a thermoset binder.

In such embodiments, the thermoset binder of the D-layer is preferably selected from the list of polyurethane, hyperbranched polyamide (optionally in combination with a crosslinking agent), thermoset polyester; isocyanates or mixtures thereof. More preferably, the relative amount of the thermoset binder of the D-layer in the combination of the thermoplastic halogen-free binder and the thermoset binder of the D-layer is between 1 and 15 mass percent.

In embodiments wherein the D-layer comprises a thermoset binder, the thermoset binder of the D-layer preferably provides at least 4 percent by weight of the D-layer. Such embodiments provide a wood-based panel having optimum performance.

A preferred D-layer comprises wood chips, wherein the mass fraction of the wood chips of the D-layer larger than 3 mm as measured via sieve analysis is less than 5 percent (and preferably less than 2 percent) of the total mass of wood chips in the D-layer; more preferably wherein the mass fraction of the wood chips of the D-layer larger than 2 mm as measured via sieve analysis is less than 5 percent (and preferably less than 2 percent) of the total mass of wood chips in the D-layer.

In a more preferred embodiment, the composition of the D-layer is the same as the composition of—if present—the B-layer or the A-layer.

In a preferred embodiment of the third aspect of the invention wherein the wood-based panel comprises the D-layer, the wood-based panel also comprises an E-layer. The E-layer provides the bottom-most wood-based layer of the wood based board. The E-layer has a thickness less than 25% of the wood-based panel. The E-layer comprises wood chips and/or wood fibers bonded by means of a thermoset resin, preferably a polyurethane resin.

It is a benefit that the E-layer provides a balancing effect to the construction of the wood-based panels, preventing deformation (e.g. cupping) of the wood-based panel.

Preferably, the thermoset resin of the E-layer (which is preferably a polyurethane resin)—provides at least 4 percent by weight—and preferably at least 7 percent by weight—of the E-layer. Such embodiments provide a wood-based panel having optimum performance.

Preferably, the E-layer comprises wood chips; wherein the mass fraction of the wood chips of the E-layer larger than 3 mm as measured via sieve analysis is less than 5 percent (and preferably less than 2 percent) of the total mass of wood chips in the E-layer. More preferably, the mass fraction of the wood chips of the E-layer larger than 2 mm as measured via sieve analysis is less than 5 percent (and preferably less than 2 percent) of the total mass of wood chips in the E-layer.

In a more preferred embodiment, the composition of the E-layer is the same as the composition of—if present—the B-layer or the A-layer.

The fourth aspect of the invention relates to a wood-based panel. Optionally, the wood-based panel of the fourth aspect of the invention is a wood-based panel as in any embodiment of the first aspect, and/or the second aspect, and/or the third aspect of the invention. The wood-based panel of the fourth aspect of the invention comprises a wood-based board and a décor layer. The wood-based board comprises a wood-based top layer comprising wood chips bonded by a binding resin. The wood-based top layer comprises a putty.

The putty can equalize the surface of the wood-based top layer.

It is a benefit of the fourth aspect of the invention that less noise is generated when walking on a floor covering formed by such wood-based panels. It is believed that as the putty creates a more level surface onto which the décor layer is applied, the décor layer is more uniformly bonded to the wood-based top layer, resulting in less noise generated when walking upon the wood-based panels.

The décor layer of the wood-based panel of the fourth aspect of the invention can comprise a décor directly printed onto the wood-based top layer. Alternatively, the décor layer of the wood-based panel of the fourth aspect of the invention can comprise a—preferably resin impregnated—printed paper sheet laminated onto the wood-based top layer. Alternatively, the décor layer of the wood-based panel of the fourth aspect of the invention comprises a High Pressure Laminate laminated onto the wood-based top layer.

A preferred embodiment of the fourth aspect of the invention is characterized in that the putty comprises on the one hand a resin selected from a urea formaldehyde resin, a melamine urea formaldehyde resin, a polyurethane resin or an acrylate resin; and on the other hand a viscosity increasing additive.

It is a benefit of such embodiments that the putty bonds very well to the wood-based top layer and that it can be applied easily filling the pores of the wood-based top layer.

A preferred embodiment of the fourth aspect of the invention is characterized in that the viscosity increasing additive consists of or comprises wood flour or cellulose powder.

Such viscosity increasing additives not only increase the viscosity resulting in better functioning of the putty when applying it, but result in a good adhesion of the décor layer onto the wood-based top layer onto which the putty has been applied. The inventors believe this is thanks to the hydroxyl groups of wood flour or of cellulose powder.

A preferred embodiment of the fourth aspect of the invention is characterized in that the viscosity increasing additive consists of or comprises an inorganic filler.

A preferred embodiment of the fourth aspect of the invention is characterized in that the viscosity increasing additive consists of or comprises a thickener.

A preferred embodiment of the fourth aspect of the invention is characterized in that the viscosity increasing additive comprises one or more than one of starch, sugar polymers (e.g. guar), carboxymethylcellulose (CMC), xanthan gum, agar, gelatin, glycols, or mineral additives such as silica, tallow, chalk.

A preferred embodiment of the fourth aspect of the invention is characterized in that the binding resin is a thermoset resin (e.g. a urea formaldehyde resin, a melamine urea formaldehyde resin, a hyperbranched polyamide—optionally in combination with a crosslinking agent—, a polyurethane resin or a di-isocyanate resin, e.g. a polymeric methylene difenyl di-isocyanate,) or a thermoplastic halogen-free binder (preferably selected from the list of polyvinyl butyral, ethylene vinyl acetate, polylactic acid, vinyl acetate-ethylene-vinyl ester copolymers, biobased polyester—e.g. polyhydroxyalkanoates—, thermoplastic polyurethanes, thermoplastic starch, thermoplastic acrylates, polyolefines or mixtures thereof).

A wood-based panel according to the fourth aspect of the invention preferably is a wood-based panel according to any embodiment of the first aspect of the invention, wherein the top layer is the B-layer.

A wood-based panel according to the fourth aspect of the invention preferably is a wood-based panel according to any embodiment of the second aspect of the invention, wherein the top layer is the A-layer.

The wood-based top layer can be a C-layer as defined earlier in this document.

The fifth aspect of the invention relates to a wood-based panel. The wood-based panel of the fifth aspect of the invention can be a wood-based panel as in the first aspect, and/or as in the second aspect, and/or as in the third aspect, and/or as in the fourth aspect of the invention. The wood-based panel of the fifth aspect of the invention is characterized in that the wood-based panel comprises an F-layer. The F-layer comprises cellulosic particles; wherein the cellulosic particles are at least in part bonded by means of a thermoset polyurethane resin. The thermoset polyurethane resin is obtained from the combination of
a di-isocyanate, preferably a polymeric methylene difenyl di-isocyanate;
a polyether polyol; and
optionally additives.

The molecular ratio of the amount of isocyanate groups in the amount of di-isocyanate used to the amount of hydroxyl groups in the amount of polyether polyol used is higher than 1, preferably higher than 2, more preferably higher than 4; and less than 10, preferably less than 8.

It is a benefit of wood-based panels according to the fifth aspect of the invention that the panels show good sound dampening properties, e.g. when walking upon a floating floor covering obtained by installing the wood-based panels.

A preferred embodiment of the fifth aspect of the invention is characterized in that the cellulosic particles are selected from wood chips, wood fibers, plant shives; or combinations thereof.

A preferred embodiment of the fifth aspect of the invention is characterized in that the hydroxyl number of the polyol is less than 100 mg KOH/gram, more preferably less than 50 mg KOH/gram, even more preferably less than 45 mg KOH/gram.

Such embodiments are preferred as wood-based panels are obtained with even better sound dampening properties when walking on the wood-based panels. It is believed that this is thanks to a more soft thermoset polyurethane which is obtained.

Preferably, the polyether polyol is a diol or a triol, or combinations thereof. More preferably, the polyether polyol has a viscosity measured at 25° C. higher than 700 mPa.s, even more preferably higher than 900 mPa.s.

Such embodiments provide wood-based panels with better sound dampening properties.

A preferred embodiment of the fifth aspect of the invention is characterized in that the wood-based panel comprises a décor layer, wherein the décor layer comprises a printed décor directly printed onto the F-layer; or wherein the décor layer comprises a—preferably resin impregnated—printed paper sheet laminated onto the F-layer; or wherein the décor layer comprises a High Pressure Laminate laminated onto the F-layer.

A preferred wood-based panel according to the fifth aspect of the invention is also a wood-based panel according to any embodiment of the first aspect of the invention, characterized in that the B-layer is the F-layer.

Such embodiments provide synergistically improved sound dampening properties to the wood-based panels, especially when walking upon such wood-based panels installed as floating floor covering.

A preferred wood-based panel according to the fifth aspect of the invention is also a wood-based panel according to any embodiment of the second aspect of the invention, characterized in that the A-layer is the F-layer.

Such embodiments provide synergistically improved sound dampening properties to the wood-based panels, especially when walking upon such wood-based panels installed as floating floor covering.

A preferred wood-based panel according to any embodiment of the first aspect, or according to any embodiment of the second aspect, or according to any embodiment of the third aspect, or according to any embodiment of the fourth aspect, or according to any embodiment of the fifth aspect of the invention, is characterized in that the wood-based panel has a density of at least 750 kg/m³.

Such embodiments have the benefit that coupling parts for coupling the wood-based panels, e.g. in a floating floor covering, can be milled more easily.

A preferred wood-based panel according to any embodiment of the first aspect, or according to any embodiment of the second aspect, or according to any embodiment of the third aspect, or according to any embodiment of the fourth aspect, or according to any embodiment of the fifth aspect of the invention, is characterized in that the wood-based panel comprises a décor layer; wherein the décor layer comprises a resin impregnated printed paper sheet laminated onto the wood-based panel; wherein the resin of the resin impregnated paper sheet is a melamine formaldehyde resin.

A preferred wood-based panel according to any embodiment of the first aspect, or according to any embodiment of the second aspect, or according to any embodiment of the third aspect, or according to any embodiment of the fourth aspect, or according to any embodiment of the fifth aspect of the invention, is characterized in that the wood-based panel comprises a décor layer; wherein the décor layer comprises a resin impregnated printed paper sheet laminated onto the wood-based panel; wherein the resin of the resin impregnated paper sheet is an acrylate resin.

It is a benefit of such embodiments that synergistically better sound attenuation properties are obtained when the wood-based panels are used as floor panels. This is believed to be due to the softer nature of acrylate resin.

The resin impregnated printed paper sheet can be laminated into the wood-based panel by means of an adhesive layer, more preferably wherein the adhesive layer is a polyurethane adhesive layer.

The polyurethane adhesive layer can be applied via an aqueous polyurethane dispersion.

A décor layer comprising a resin impregnated printed paper sheet can be laminated into the wood-based panel via laminating a High Pressure Laminate into the wood-based panel.

A preferred wood-based panel according to any embodiment of the first aspect, or according to any embodiment of the second aspect, or according to any embodiment of the third aspect, or according to any embodiment of the fourth aspect, or according to any embodiment of the fifth aspect of the invention, is characterized in that the wood-based panel comprises a wear layer, wherein the wear layer is selected from a paper sheet impregnated with a melamine formaldehyde resin, a paper sheet impregnated with an acrylate resin, or an acrylate lacquer layer.

The use of a wear layer comprising a paper sheet impregnated with an acrylate resin or a wear layer comprising an acrylate lacquer layer is preferred, as such wood based panels create less noise when used, especially when a scratching movement is made on the surface of the panels.

The wear layer can comprise abrasion resistant particles, or the wear layer can be devoid of abrasion resistant particles.

A preferred wood-based panel according to any embodiment of the first aspect, or according to any embodiment of the second aspect, or according to any embodiment of the third aspect, or according to any embodiment of the fourth aspect, or according to any embodiment of the fifth aspect of the invention, is characterized in that the décor layer comprises a resin impregnated printed paper sheet laminated onto the wood-based panel; wherein the resin of the resin impregnated paper sheet is a melamine formaldehyde resin; and wherein the wear layer is selected from a paper sheet impregnated with an acrylate resin or an acrylate lacquer layer; and wherein the wear layer is adhered onto the décor layer by means of an adhesive layer, preferably by means of a polyurethane adhesive layer.

A preferred wood-based panel according to any embodiment of the first aspect, or according to any embodiment of the second aspect, or according to any embodiment of the third aspect, or according to any embodiment of the fourth aspect, or according to any embodiment of the fifth aspect of the invention, is characterized in that the thickness of the panel is more than 6.5 mm, preferably more than 7.5 mm, preferably more than 8.5 mm, more preferably more than 9.5 mm, and preferably less than 14 mm, more preferably less than 13 mm.

A preferred wood-based panel according to any embodiment of the first aspect, or according to any embodiment of the second aspect, or according to any embodiment of the third aspect, or according to any embodiment of the fourth aspect, or according to any embodiment of the fifth aspect of the invention, is characterized in that the wood-based board has in thickness direction a symmetric layer composition.

Such embodiment has the benefit that a more dimensionally stable wood-based panel is obtained, as the risk of deformation—e.g. cupping—is minimal.

A preferred wood-based panel according to any embodiment of the first aspect, or according to any embodiment of the second aspect, or according to any embodiment of the third aspect, or according to any embodiment of the fourth aspect, or according to any embodiment of the fifth aspect of the invention, is characterized in that the wood-based panel comprises a décor layer; wherein the wood-based panel comprises on its decorative surface embossments with depth larger than 500 μm.

Softness at the surface of the wood-based panels provides the creation of decorative surface embossments with depth larger than 500 μm. Therefore, a more realistic imitation of natural wood can be made.

A preferred wood-based panel according to any embodiment of the first aspect, or according to any embodiment of the second aspect, or according to any embodiment of the third aspect, or according to any embodiment of the fourth aspect, or according to any embodiment of the fifth aspect of the invention, is characterized in that the panel is rectangular—square or oblong—, wherein the panel comprises at least at two opposite side edges coupling parts for coupling the panel with a second such panel at their respective side edges; wherein in coupled condition a locking is provided in the direction perpendicular to the surface of the coupled panels; as well as a locking is provided in the direction perpendicular to the coupled side edges and parallel to the surface of the coupled panels. The coupling parts comprise at one of the two opposite side edges a male coupling part. The coupling parts comprise at the other one of the two opposite side edges a female coupling part.

Preferably, the male coupling part comprises a tongue; and the female coupling part comprises a groove, wherein the groove is bordered by an upper lip and by a lower lip. The lower lip preferably extends more distal than the upper lip.

The coupling parts are preferably configured as on the one hand a tongue and on the other hand a groove bordered by an upper lip and a lower lip; wherein the tongue and the groove provide in coupled condition a locking in the direction perpendicular to the surface of the coupled panels. The tongue and the groove comprise locking parts, wherein the locking parts provide in coupled condition a locking in the direction perpendicular to the coupled side edges and parallel to the surface of the coupled panels. More preferably the locking parts comprise a protrusion at the lower lip and a corresponding recess at the bottom of the tongue.

Preferably, the coupling parts are configured such that the coupling can be performed by means of an angling movement of the respective side edges of the panels to be coupled.

The sixth aspect of the invention relates to a method for producing a wood-based board. The method comprises the steps of
mixing a di-isocyanate (preferably a polymeric methylene difenyl di-isocyanate), a polyether polyol, and optionally additives, thereby forming a two-component binder;
applying the two-component binder to cellulosic particles;
scattering the cellulosic particles onto which the two-component binder has been applied into panel shape; and
curing the two-component binder by compressing the scattered cellulosic particles at increased temperature thereby obtaining the wood-based board;
wherein the molecular ratio of the amount of isocyanate groups in the amount of di-isocyanate used to the amount of hydroxyl groups in the amount of polyether polyol used is higher than 1, preferably higher than 2, more preferably higher than 4; and less than 10, preferably less than 8.

It is a benefit of the method of the sixth aspect of the invention that a wood-based panel is obtained showing good sound dampening properties, e.g. when walking upon a floating floor covering obtained by installing the wood-based panels.

The cellulosic particles are preferably selected from wood chips, wood fibers, plant shives; or combinations thereof.

A preferred embodiment of the sixth aspect of the invention is characterized in that the hydroxyl number of the polyol is less than 100 mg KOH/gram, more preferably less than 50 mg KOH/gram, and more preferably less than 45 mg KOH/gram.

Such embodiments are preferred as wood-based panels are obtained with even better sound dampening properties when walking on the wood-based panels. It is believed that this is thanks to a more soft thermoset polyurethane which is obtained.

A preferred embodiment of the sixth aspect of the invention is characterized in that the polyether polyol is a diol or a triol, or combinations thereof.

Such embodiments provide wood-based panels with better sound dampening properties.

A preferred embodiment of the sixth aspect of the invention is characterized in that the polyether polyol has a viscosity measured at 25° C. higher than 700 mPa.s, more preferably higher than 900 mPa.s.

Such embodiments provide wood-based panels with better sound dampening properties.

With the intention of better showing the characteristics of the invention, hereafter, as an example without any limitative character, several preferred embodiments are described, with reference to the accompanying drawings, wherein:

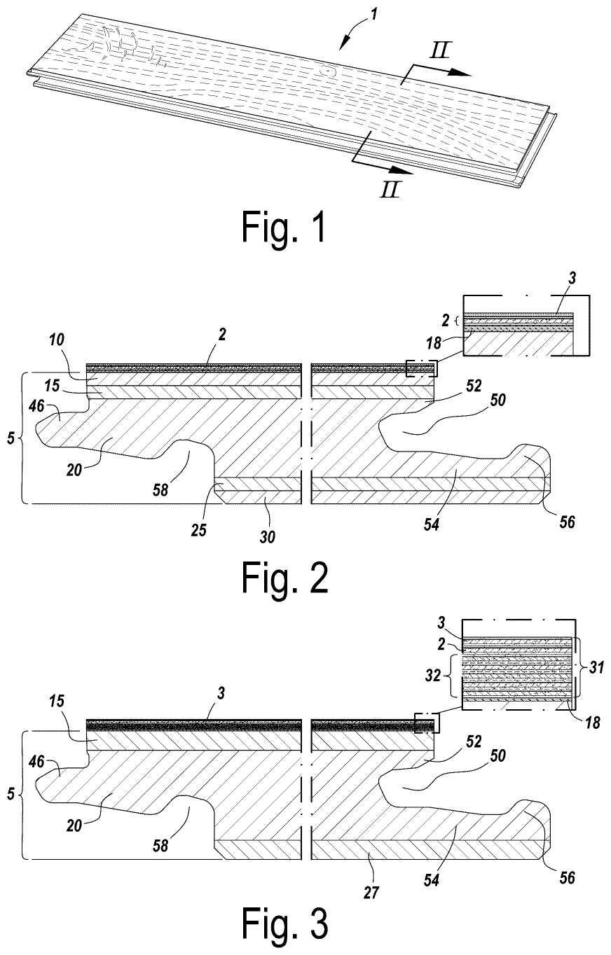

FIG. 1 shows a panel according to the invention;

FIGS. 2-4 show cross sections according to II-II of FIG. 1 of embodiments of wood-based panels according to aspects of the invention; and

FIG. 5 shows a wood-based panel according to the fourth aspect of the invention.

FIG. 1 shows a panel 1 according to aspects of the invention.

FIG. 2 shows a cross section according to II-II of FIG. 1 of an example of a wood-based panel according to aspects of the invention. The wood-based panel comprises a wear layer 3, a décor layer 2, and a wood-based board 5. The wood-based board 5 comprises an A-layer 10, a B-layer 15, a C-layer 20, a D-layer 25 and an E-layer 30.

The wood-based panel of FIG. 1 is 12 mm thick. The A-layer 10 provides 10% of the thickness of the wood-based board 5; the B-layer 15 provides 10% of the thickness of the wood-based board 5; the C-layer 20 provides 60% of the thickness of the wood-based board 5; the D-layer 25 provides 10% of the thickness of the wood-based board 5; and the E-layer 30 provides 10% of the thickness of the wood-based board 5.

The density of the wood-based panel of FIG. 2 is 775 kg/m³.

The décor layer 2 comprises a resin impregnated printed paper sheet laminated onto the wood-based panel by means of a polyurethane adhesive layer 18. The resin with which the printed paper sheet is impregnated is an acrylate resin.

The wear layer 3 in the example of FIG. 2 is an acrylate lacquer layer.

The A-layer 10 comprises wood chips bonded by a thermoset polyurethane resin. The thermoset polyurethane resin provides 9 percent by weight of the A-layer 10.

The polyurethane resin has been obtained in situ during the production of the A-layer. The polyurethane resin is obtained from the combination of a polymeric methylene difenyl di-isocyanate and a polyether polyol. The polyol used is a polyether triol having hydroxyl number 40 mg KOH/gram and a viscosity at 25° C. of 1070 mPa.s. The molecular ratio of the amount of isocyanate groups in the amount of di-isocyanate used to the amount of hydroxyl groups in the amount of polyether polyol used is 6.68. The polymeric methylene difenyl di-isocyanate and the polyether polyol have been mixed immediately before applying the mixture to the wood chips just prior to scattering the wood chips to form the A-layer. The A-layer 10 of the wood-based panel of example 1 is thus an F-layer according to the terminology used in this document.

The A-layer 10 has been manufactured using wood chips all smaller than 2 mm when measured according to the sieve analysis method described in this document. The mass fraction of the wood chips of the A-layer 10 smaller than 1 mm as measured via sieve analysis is more than 50 percent. More than 80 percent by weight of the wood chips of the A-layer have a size between 0.3 mm and 2 mm.

Thanks to the use of a blower when scattering the wood chips in the production of the A-layer, the fraction by mass of fine chips in the A-layer is larger at the front side of the A-layer than at the back of the A-layer. The front side of the A-layer is the side directed to the décor layer 2.

The A-layer 10 comprises 0.89 percent by weight of wax.

The B-layer 15 comprises wood chips bonded by a thermoplastic halogen-free binder and by a thermoset polyurethane binder.

As thermoplastic halogen-free binder, polyvinyl butyral (PVB) has been used. The fraction by volume in the B-layer 15 of polyvinyl butyral (PVB) in the combination of the wood chips of the B-layer 15 and the polyvinyl butyral (PVB) amounts to 33%.

The thermoset polyurethane binder of the B-layer 15 is the same thermoset polyurethane binder as in the A-layer 10. The B-layer 15 of the example of FIG. 2 is thus an F-layer according to the terminology used in this document. The B-layer 15 comprises 8 percent by weight of the thermoset polyurethane binder.

The B-layer 15 of the wood-based panel of FIG. 2 comprises the same size distribution of wood chips as the A-layer 10.

The B-layer 15 comprises 0.89 percent by weight of wax.

The C-layer 20 is a wood particle board layer comprising wood chips and a binder. Instead of a wood particle board layer, the C-layer can be a wood fiber board, e.g. a Medium Density Fiberboard or a High Density Fiberboard.

The C-layer 20 of the example of FIG. 2 is a wood particle board layer comprising wood chips and a melamine urea formaldehyde binder. The melamine urea formaldehyde binder provides 13 percent by weight of the C-layer 20.

The C-layer 20 has been manufactured using wood chips all smaller than 6 mm when measured according to the sieve analysis method described in this document.

The density of the C-layer 20 was 750 kg/m³.

The C-layer 20 comprises 0.89 percent by weight wax.

The D-layer 25 has the same composition as the B-layer 15. Alternatively, the D-layer can have a similar composition as the B-layer, but without the polyvinyl butyral (PVB) thermoplastic binder, meaning that the wood chips are fully bonded by means of the thermoset polyurethane resin.

The E-layer 30 has the same composition as the A-layer 10.

The wood-based panel of FIG. 2 has through its thickness a symmetrical composition, which is beneficial against deformations such as cupping.

The wood-based panel of FIG. 2 comprises at opposite side edges coupling parts for coupling the wood-based panel with a second such wood-based panel at their respective side edges. The coupling parts comprise at one of the two edges a male coupling part comprising a tongue 46. The coupling parts comprise at the other one of the two edges a female coupling part comprising a groove 50, bordered by an upper lip 52 and by a lower lip 54. The lower lip 54 extends more distal than the upper lip 52. The tongue 46 and the groove 50 provide in coupled condition a locking in the direction perpendicular to the surface of the coupled layered panels.

The tongue 46 and the groove 50 comprise locking parts 56, 58 providing in coupled condition a locking in the direction perpendicular to the coupled side edges and parallel to the surface of the coupled layered panels. In the example shown, the locking parts 56, 58 comprise a protrusion 56 at the lower lip 54, and a corresponding recess 58 at the bottom of the tongue 46.

FIG. 3 shows a cross section according to II-II of FIG. 1 of an example of a wood-based panel according to aspects of the invention.

The wood-based panel of FIG. 3 comprises a wear layer 3, a décor layer 2, and a wood-based board 5. The wood-based board 5 comprises a B-layer 15, a C-layer 20, and a D-layer 27.

The wood-based panel of FIG. 1 is 11 mm thick. The B-layer 15 provides 15% of the thickness of the wood-based board 5; the C-layer 20 provides 70% of the thickness of the wood-based board 5; and the D-layer 27 provides 15% of the thickness of the wood-based board 5.

The wood-based panel of FIG. 3 comprises a High Pressure Laminate (HPL) 31 incorporating the décor layer 2 and the wear layer 3. The High Pressure Laminate (HPL) 31 comprises a resin impregnated printed sheet of paper 2 providing a printed décor, a number of layers of Kraft paper 32 impregnated with resin, and a wear layer 3 on top of the décor layer 2. The wear layer 3 is provided by a resin impregnated sheet of paper and comprises wear resistant particles. The High Pressure Laminate has been laminated onto the B-layer 15 of the wood-based panel of FIG. 3 using an adhesive 18, e.g. using a polyurethane adhesive applied to the back of the High Pressure Laminate as an aqueous polyurethane dispersion.

The B-layer 15 of the wood-based panel of FIG. 3 has the same composition as the B-layer of the wood-based panel of FIG. 2.

The C-layer 20 of the wood-based panel of FIG. 3 can have the same composition as the C-layer 20 of the wood-based panel of FIG. 2.

The D-layer 27 of the wood-based panel of FIG. 3 has the same composition as the D-layer 25 of the wood-based panel of FIG. 3. It is also possible that the wood chips of the D-layer 27 of the example shown in FIG. 3 are only bonded by a thermoset binder, which can a thermoset polyurethane. However, other thermoset binders can also be used.

The wood-based panel of FIG. 3 comprises at opposite side edges coupling parts for coupling the wood-based panel with a second such wood-based panel at their respective side edges. The coupling parts comprise at one of the two edges a male coupling part comprising a tongue 46. The coupling parts comprise at the other one of the two edges a female coupling part comprising a groove 50, which is bordered by an upper lip 52 and by a lower lip 54. The lower lip 54 extends more distal than the upper lip 52. The tongue 46 and the groove 50 provide in coupled condition a locking in the direction perpendicular to the surface of the coupled layered panels.

The tongue 46 and the groove 50 comprise locking parts 56, 58 providing in coupled condition a locking in the direction perpendicular to the coupled side edges and parallel to the surface of the coupled layered panels. In the example shown, the locking parts 56, 58 comprise a protrusion 56 at the lower lip 54, and a corresponding recess 58 at the bottom of the tongue 46.

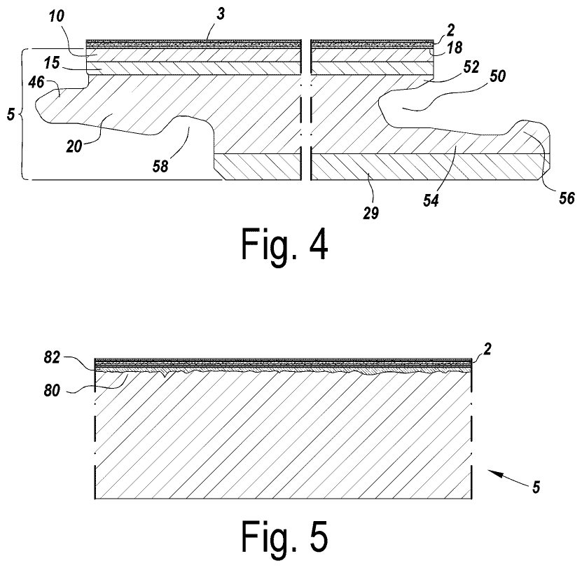

FIG. 4 shows a cross section according to II-II of FIG. 1 of an example of a wood-based panel according to aspects of the invention.

The wood-based panel of FIG. 1 is 12 mm thick. The wood-based panel comprises a wear layer 3, a décor layer 2, and a wood-based board 5. The wood-based board 5 comprises an A-layer 10, a B-layer 15, a C-layer 20, and an additional layer 29.

The A-layer 10 provides 10% of the thickness of the wood-based board 5; the B-layer 15 provides 10% of the thickness of the wood-based board 5; the C-layer 20 provides 60% of the thickness of the wood-based board 5; and the additional layer 29 provides 20% of the thickness of the wood-based board 5.

The décor layer 2 comprises a resin impregnated printed paper sheet laminated onto the wood-based panel by means of a polyurethane adhesive layer 18. The resin with which the printed paper sheet is impregnated is an acrylate resin. The wear layer 3 in the example of FIG. 4 is an acrylate lacquer layer.

The A-layer 10 can have the same composition as the A-layer 10 described in the example of FIG. 2.

The B-layer 15 can have the same composition as the B-layer 15 described in the example of FIG. 2.

The C-layer 20 can have the same composition as the C-layer 20 described in the example of FIG. 2.

The additional layer 29 provides the bottom-most wood-based layer of the wood based board 5 of the example of FIG. 4. The additional layer comprises wood chips bonded by means of a thermoset resin, e.g. by a polyurethane resin or by a urea formaldehyde resin or by a melamine urea formaldehyde resin.

The wood-based panel of FIG. 4 comprises at opposite side edges coupling parts for coupling the wood-based panel with a second such wood-based panel at their respective side edges. The coupling parts comprise at one of the two edges a male coupling part comprising a tongue 46. The coupling parts comprise at the other one of the two edges a female coupling part comprising a groove 50, which is bordered by an upper lip 52 and by a lower lip 54. The lower lip 54 extends more distal than the upper lip 52. The tongue 46 and the groove 50 provide in coupled condition a locking in the direction perpendicular to the surface of the coupled layered panels.

The tongue 46 and the groove 50 comprise locking parts 56, 58 providing in coupled condition a locking in the direction perpendicular to the coupled side edges and parallel to the surface of the coupled layered panels. In the example shown, the locking parts 56, 58 comprise a protrusion 56 at the lower lip 54, and a corresponding recess 58 at the bottom of the tongue 46.

FIG. 5 shows an embodiment of a wood-based panel according to the fourth aspect of the invention. The wood-based panel comprises a wood-based board 5 and a décor layer 2. The wood-based board comprises a wood-based top layer 80 comprising wood chips bonded by a binding resin. The wood-based top layer comprises a putty 82. The putty 82 is applied to equalize the surface of the wood-based top layer 80. This way, a more level surface is provided for applying the décor layer 2.

The decor layer 2 can be provided by a décor directly printed onto the wood-based top layer. Alternatively, the décor layer can comprise a resin impregnated printed paper sheet laminated onto the wood-based top layer. It is possible that the décor layer is provided by laminating a High Pressure Laminate onto the wood-based top layer.

In the example, the putty 82 comprises a polyurethane resin and a viscosity increasing additive. However, other types of resin can be used for the putty.

In an example, the viscosity increasing additive comprises wood flour. In addition, or as an alternative to the used of wood flour, the viscosity increasing additive can be a thickener, which can be selected from starch, sugar polymers (e.g. guar), carboxymethylcellulose (CMC), xanthan gum, agar, gelatin, or glycols.

The wood-based panel of FIG. 5 can be a wood-based panel as shown in FIG. 2, or a wood-based panel as shown in FIG. 3, or a wood-based panel as shown in FIG. 4.

The present invention is in no way limited to the embodiments described as an example and represented in the figures, on the contrary it can be realized in various forms and dimensions, without leaving the scope of the invention.

1-76. (canceled)

77. A wood-based panel, wherein the wood-based panel comprises a wood-based board and a décor layer,
wherein the wood-based board comprises an A-layer, wherein the A-layer has a thickness less than 35 % of the wood-based panel;
wherein the A-layer comprises wood chips bonded by a thermoset resin;
wherein the wood-based panel has a density of at least 750 kg/m3 and
wherein the thermoset resin provides at least 4 percent by weight of the A-layer.

78. The wood-based panel as in claim 77, wherein the A-layer comprises wood chips;
wherein the mass fraction of the wood chips of the A-layer larger than 3 mm as measured via sieve analysis is less than 5 percent of the total mass of wood chips in the A-layer;
wherein the mass fraction of the wood chips of the A-layer larger than 2 mm as measured via sieve analysis is less than 5 percent of the total mass of wood chips in the A-layer.

79. The wood-based panel as in claim 77, wherein in the A-layer the mass fraction of the wood chips with size between 0.3 mm and 2 mm is at least 80 wt % of the total mass of wood chips in the A-layer.

80. The wood-based panel as in claim 77, wherein the A-layer comprises wood chips;
wherein the fraction by mass of fine chips in the A-layer is larger at the front side of the A-layer than at the back of the A-layer.

81. The wood-based panel as in claim 77, wherein the A-layer comprises at least 0.5 wt % of wax.

82. The wood-based panel as in claim 77, wherein the décor layer comprises a décor directly printed onto the A-layer, or the décor layer comprises a printed paper sheet laminated onto the A-layer, or the décor layer comprises a High Pressure Laminate laminated onto the A-layer.

83. The wood-based panel as in claim 77, wherein the wood-based board comprises a C-layer,
wherein the C-layer provides more than 40% of the thickness of the wood-based board;
wherein the C-layer is a wood particle board layer comprising wood chips and a binder;
wherein the density of the C-layer is more than 700 kg/m3 .

84. The wood-based panel as in claim 83, wherein the binder of the C-layer comprises or consists of a thermoset binder, selected from the list of urea formaldehyde resin, melamine urea formaldehyde resin, diisocyanate, polyurethane, hyperbranched polyamide, thermoset polyester, or mixtures thereof.

85. The wood-based panel as in claim 84, wherein the thermoset binder provides at least 4 wt % of the C-layer.

86. The wood-based panel as claim 83, wherein the C-layer is a wood particle board layer comprising wood chips and a binder;
wherein the mass fraction of the wood chips of the C-layer larger than 8 mm as measured via sieve analysis is less than 5 percent of the total mass of the wood chips of the C-layer; and
wherein the mass fraction of the wood chips of the C-layer larger than 7 mm as measured via sieve analysis is less than 5 percent of the total mass of the wood chips of the C-layer.

87. The wood-based panel as in claim 83, wherein the C-layer is a wood particle board layer comprising wood chips and a thermoset binder;
wherein the mass fraction of the wood chips of the C-layer smaller than 6 mm as measured via sieve analysis is more than 50 percent of the total mass of wood chips in the C-layer.

88. The wood-based panel as in claim 83, wherein the A-layer is provided between the C-layer and the décor layer.

89. The wood-based panel as in claim 83, wherein at the other side of the wood-based panel than the location of the décor layer, the wood-based board comprises a D-layer;
wherein the D-layer comprises wood chips and/or wood fibers bonded by a thermoplastic halogen-free binder; and/or by a thermoset binder.

90. The wood-based panel as in claim 89, wherein the D-layer comprises wood chips and/or wood fibers bonded by a thermoset binder.

91. The wood-based panel as in claim 89, wherein the wood-based panel comprises an E-layer,
wherein the E-layer is the bottom-most wood-based layer of the wood based board;
wherein the E-layer has a thickness less than 25% of the wood-based panel;
wherein the E-layer comprises wood chips and/or wood fibers bonded by means of a thermoset resin.
